(19) United States
(12) Patent Application Publication
(10) Pub. No.: US 2026/0184092 A1
(43) Pub. Date: Jul. 2, 2026

(54) SHEET STACKING APPARATUS AND IMAGE FORMING SYSTEM

(71) Applicant: CANON KABUSHIKI KAISHA, Tokyo (JP)

(72) Inventor: JUNYA TAKATSU, Tokyo (JP)

(21) Appl. No.: 19/425,606

(22) Filed: Dec. 18, 2025

(30) Foreign Application Priority Data
Dec. 26, 2024 (JP) 2024-230578

(51) Int. Cl. B41J 13/10; B41J 13/00

(52) U.S. Cl. CPC B41J 13/106; B41J 13/0036

(57) ABSTRACT

To improve the positional accuracy of a stacking tray, a sheet stacking apparatus includes a stacking portion on which a sheet is to be stacked, a motor configured to output drive force for elevating and lowering the stacking portion, a rotation detection unit configured to detect a rotation amount of the motor, and a control unit configured to set a target rotation amount of the motor when the stacking portion is lowered in accordance with a sheet being stacked on the stacking portion, and perform feedback control of the motor based on the target rotation amount and a detection result of the rotation detection unit, wherein the control unit changes a control parameter of the feedback control in accordance with information related to a weight of sheets stacked on the stacking portion.

### BACKGROUND

### Field of the Technology

The present disclosure relates to a sheet stacking apparatus that stacks sheets, and an image forming system to which the sheet stacking apparatus is applied.

### Description of the related Art

In recent years, along with the speeding up of image formation processing in an image forming apparatus, the speeding up of sheet stacking processing adapted to a sheet discharge speed, and a good aligned state of a stacked sheet bundle have been demanded also in a sheet stacking apparatus in order to stack sheets discharged at high speed. In addition, along with an increased stacking capacity of the sheet stacking apparatus that is attributed to the handling of long sheets or the like, the weight of stacked sheets has increased. When sheets are stacked in the sheet stacking apparatus, a stacking tray (stacking portion) on which sheets are to be stacked is lowered in accordance with sheet discharge. In addition, to take out sheets stacked on a stacking tray, the stacking tray is elevated and lowered. There has been described the control of changing an elevating/lowering speed of a stacking tray based on a stacked sheet weight when a sheet stacked on such a stacking tray is taken out (refer to Japanese Patent Laid-Open No. 2011-190052).

Nevertheless, in the sheet stacking apparatus described in Japanese Patent Laid-Open No. 2011-190052, control has not been performed based on the stacked sheet weight when sheets are stacked. For this reason, there has been an issue that, when sheets are stacked, a variation in actual position of the stacking tray with respect to a target lowering amount of the stacking tray becomes larger as the number of stacked sheets increases and the stacked sheet weight gets heavier.

### SUMMARY

The present disclosure is directed to providing a sheet stacking apparatus and an image forming system that can improve positional accuracy of the stacking tray.

According to some embodiments of the present disclosure, a sheet stacking apparatus includes a stacking portion on which a sheet is to be stacked, a motor configured to output drive force for elevating and lowering the stacking portion, a rotation detection unit configured to detect a rotation amount of the motor, and a control unit configured to set a target rotation amount of the motor when the stacking portion is lowered in accordance with a sheet being stacked on the stacking portion, and perform feedback control of the motor based on the target rotation amount and a detection result of the rotation detection unit, wherein the control unit changes a control parameter of the feedback control in accordance with information related to a weight of sheets stacked on the stacking portion.

According to another aspect of the present disclosure, a sheet stacking apparatus includes a stacking portion on which a sheet is to be stacked, a motor configured to output drive force for elevating and lowering the stacking portion, a rotation detection unit configured to detect a rotation amount of the motor, and a control unit configured to set a target rotation amount of the motor when the stacking portion is lowered in accordance with a sheet being stacked on the stacking portion, and perform feedback control of the motor based on the target rotation amount and a detection result of the rotation detection unit, wherein the control unit changes a control parameter of the feedback control in accordance with the number of sheets stacked on the stacking portion.

According to yet another aspect of the present disclosure, an image forming system includes an image forming apparatus configured to form an image on a sheet, and a sheet stacking apparatus that is configured to receive a sheet on which an image is formed by the image forming apparatus, and stack the sheet on the stacking portion.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming system according to a first embodiment.

FIG. 2 is a cross-sectional view illustrating a discharge module according to the first embodiment.

FIG. 3 is a block diagram illustrating a control system of the discharge module according to the first embodiment.

FIG. 4 is a block diagram illustrating a feedback control system of the discharge module according to the first embodiment.

FIG. 5 is a time chart illustrating a control procedure of the discharge module according to the first embodiment.

FIG. 6 is a flowchart illustrating the control procedure of the discharge module according to the first embodiment.

FIG. 7 is a time chart illustrating a control procedure of a discharge module according to a second embodiment.

FIG. 8 is a flowchart illustrating the control procedure of the discharge module according to the second embodiment.

### DESCRIPTION OF THE EMBODIMENTS

### First Embodiment

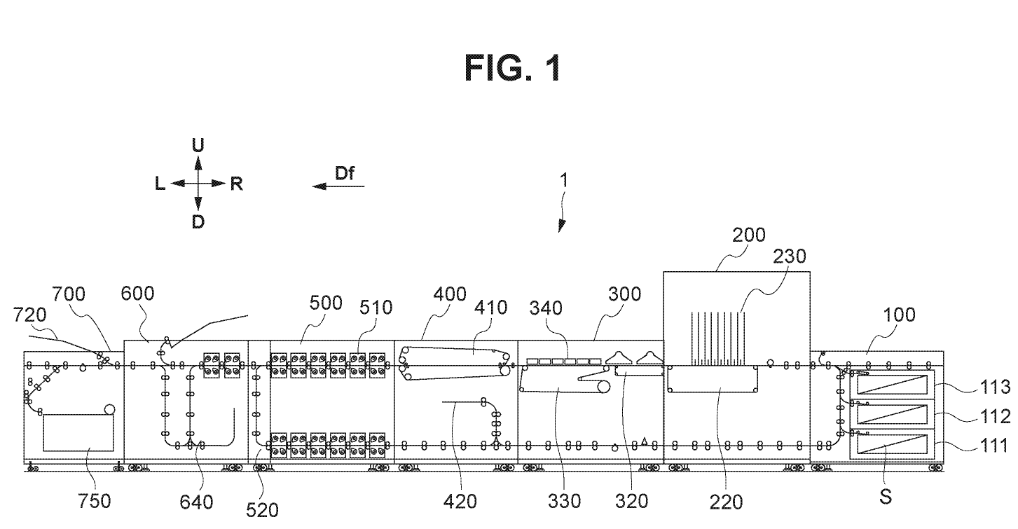

Hereinafter, the first embodiment will be described with reference to FIGS. 1 to 6. In the present embodiment, a case where an image forming system is applied to an inkjet recording system 1 will be described. FIG. 1 is a schematic diagram illustrating an example of a schematic configuration of the inkjet recording system 1. The inkjet recording system 1 is a sheet-fed inkjet recording system that manufactures a recorded product by forming an ink image on a sheet S using two types of liquid including reaction liquid and ink. As illustrated in FIG. 1, the inkjet recording system 1 includes a feeding module 100, a print module 200, a drying module 300, a fixing module 400, a cooling module 500, a reversing module 600, and a stacking module 700. The sheet S with a cut sheet shape that is supplied from the feeding module 100 is conveyed along a conveyance path, subjected to processing in each module, and stacked in the stacking module 700. The sheet in the present embodiment refers to a recording material, and includes paper such as a sheet and an envelope, a plastic film such as an overhead projector (OHP) sheet, cloth, and the like. In addition, in the present embodiment, the inkjet recording system 1 is arranged in such a manner that a sheet conveyance direction Df corresponds to a left-right direction of the inkjet recording system 1, and when viewed from the front side, a right side will be described as a right direction R, a left side will be described as a left direction L, an upside will be described as an upper direction U, and a downside will be described as a down direction D.

By conveying a sheet with being connected to the print module 200, the feeding module 100 supplies the sheet to the print module 200, and performs the delivery and receipt of sheets with the print module 200. The feeding module 100 includes, as a sheet supply unit that stores and feeds the sheet S, a first supply unit 111, a second supply unit 112, and a third supply unit 113. The first supply unit 111 includes a first storage unit 111a that stores the sheet S, and a first feeding unit 111b that feeds the sheet S from the first storage unit 111a. The second supply unit 112 includes a second storage unit 112a that stores the sheet S, and a second feeding unit 112b that feeds the sheet S from the second storage unit 112a. The third supply unit 113 includes a third storage unit 113a that stores the sheet S, and a third feeding unit 113b that feeds the sheet S from the third storage unit 113a. The first storage unit 111a, the second storage unit 112a, and the third storage unit 113a each can store a plurality of sheets, and each have a configuration of being drawable to an apparatus front side. The sheets S in the first storage unit 111a, the second storage unit 112a, and the third storage unit 113a are respectively separated by the first feeding unit 111b, the second feeding unit 112b, and the third feeding unit 113b, are fed one by one, and conveyed to the print module 200. The number of supply units is not limited to three, and may be one or two, or a configuration including four supply units or more may be employed. The feeding module 100 will be described.

The print module 200 is an example of an image forming apparatus, includes a pre-image-formation registration correction unit (not illustrated), a print belt unit 220, and a recording unit 230, and conveys the sheet S. The inclination and the position of the sheet S conveyed from the feeding module 100 are corrected by the pre-image-formation registration correction unit, and the sheet S is conveyed to the print belt unit 220. The recording unit 230 is arranged at a position facing the print belt unit 220 with respect to the conveyance path. The recording unit 230 forms an image by performing recording processing (printing) on the sheet S using a recording head from above the conveyed sheet S. A plurality of recording heads is arranged along a conveyance direction. In the present embodiment, the recording unit 230 includes five line-type recording heads in total that correspond to reaction liquid in addition to four colors including yellow (Y), magenta (M), cyan (C), and black (Bk). The number of colors is not limited to four, and the number of recording heads is not limited to five. As an inkjet method, a method that uses a heater element, a method that uses a piezoelectric element, a method that uses an electrostatic element, a method that uses a microelectromechanical system (MEMS) element, or the like can be employed. Ink of each color is supplied from an ink tank (not illustrated) to the recording head via an ink tube. By being sucked and conveyed by the print belt unit 220, the sheet S printed by the recording unit 230 is conveyed with a clearance from the recording head being ensured. The shift and the color density of an image formed on the sheet S are detected from the sheet S printed by the recording unit 230, by an in-line scanner (not illustrated) arranged on the sheet conveyance direction downstream side of the recording unit. A detection result is used for the correction of an image to be printed.

The drying module 300 includes a decoupling unit 320, a drying belt unit 330, and a hot-air blowing unit 340, and increases a fixing property of the sheet S and ink by decreasing liquid components contained in ink applied onto the sheet S by the recording unit 230 of the print module 200. The sheet S printed by the recording unit 230 of the print module 200 is conveyed to the decoupling unit 320 arranged on the sheet conveyance direction upstream side of the drying module 300. The decoupling unit 320 can convey the sheet S by wind pressure applied from above and the friction of a belt, and by conveying the sheet S with weakly holding the sheet S on the belt, prevents the shift of the sheet S on the print belt unit 220 that forms an ink image. The drying belt unit 330 is arranged below the belt, and the hot-air blowing unit 340 is arranged above the belt, with both facing each other across the belt. Concurrently with being sucked and conveyed by the drying belt unit 330, the sheet S conveyed from the decoupling unit 320 receives hot air from the hot-air blowing unit 340, and an ink applied surface is dried. As a drying method, aside from a method of applying hot air, a method of emitting electromagnetic waves (ultraviolet rays, infrared rays, etc.) to the surface of the sheet S, and a conduction heat transfer method by the contact of a heat generator may be used in combination.

The fixing module 400 includes a fixing belt unit 410. The fixing belt unit 410 includes an upper belt unit and a lower belt unit, and can fix ink to the sheet S by causing the sheet S conveyed from the drying module 300, to pass through a space between the heated upper belt unit and lower belt unit.

The cooling module 500 includes a plurality of cooling units 510, and cools the high-temperature sheet S conveyed on a sheet conveyance path from the fixing module 400. The cooling unit 510 is configured to cool the sheet S by taking external air into a cooling box using a fan, raising the pressure in the cooling box, and applying wind blown out from a nozzle formed on a conveyance guide, to the sheet S. The cooling units 510 are arranged on both of the upper side and the lower side of the conveyance path, and cool the sheet S from both surfaces.

In addition, the cooling module 500 includes a conveyance path switching unit 520, and can switch a conveyance path of the sheet S in accordance with the case of conveying the sheet S to the reversing module 600, and the case of conveying the sheet S to a duplex conveyance path to be used at the time of duplex printing. At the time of duplex printing, the sheet S is conveyed to a conveyance path at a lower part of the cooling module 500. In this case, the sheet S is further conveyed from the cooling module 500 along duplex conveyance paths of the fixing module 400, the drying module 300, the print module 200, and the feeding module 100. On the duplex conveyance path of the fixing module 400, a first reversing unit 420 that reverses the front side and the back side of the sheet S is provided. Then, the sheet S is conveyed again from the feeding module 100 to the pre-image-formation registration correction unit, the print belt unit 220, and the recording unit 230 of the print module 200, and printing is performed in the recording unit 230.

The reversing module 600 includes a second reversing unit 640, and can reverse the front side and the back side of the conveyed sheet S, and change the front and back of the sheet S to be discharged. The stacking module 700 is an example of a sheet stacking apparatus, includes a top tray 720 and a stacking unit 750, and aligns and stacks the sheets S conveyed from the reversing module 600.

### Stacking Module

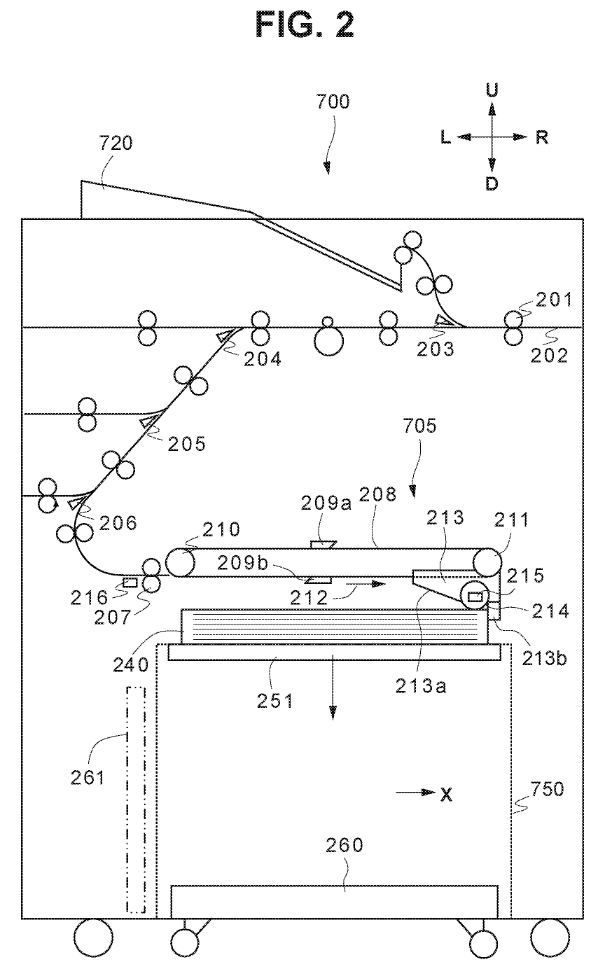

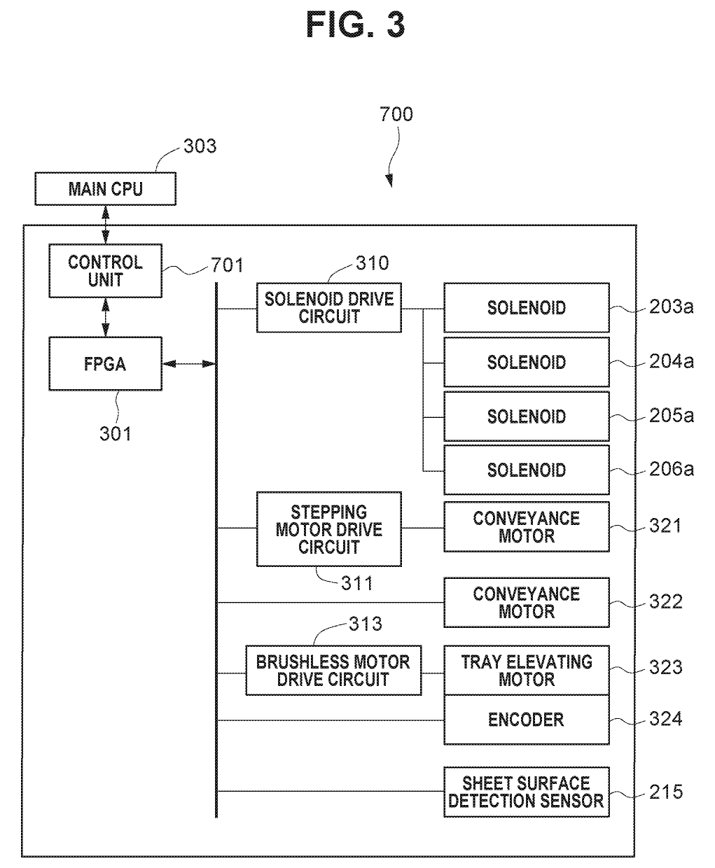

Next, a configuration of the stacking module 700 will be described with reference to FIG. 2. FIG. 2 is a cross-sectional schematic view illustrating the stacking module 700. If the sheet S is discharged from the reversing module 600, the sheet S is conveyed into a conveyance roller 201, and conveyed on a conveyance path 202. In accordance with a selection instruction issued from a main body operation unit (not illustrated) or the like, the conveyed sheet S is conveyed with a sheet conveyance direction being switched by a switching unit 203 that switches a sheet conveyance path by pivoting. The switching unit 203 is switched by a solenoid 203a (refer to FIG. 3).

In a case where the user designates the top tray 720 on the top surface of the stacking module 700 as a sheet discharge destination, a control unit 701 (refer to FIG. 3) performs drive control of the switching unit 203 using the solenoid 203a, and the switching unit 203 is pivoted in such a manner that a leading end is oriented downward. The sheet S is conveyed and discharged to the top tray 720 by the guiding of the switching unit 203.

In a case where the user designates, as a sheet discharge destination, the stacking unit 750 provided at a downstream of the stacking module 700, the control unit 701 performs drive control of the switching unit 203, a switching unit 204, a switching unit 205, and a switching unit 206. The switching unit 204 is switched by a solenoid 204a (refer to FIG. 3), the switching unit 205 is switched by a solenoid 205a (refer to FIG. 3), and the switching unit 206 is switched by a solenoid 206a (refer to FIG. 3). All of the switching unit 203, the switching unit 204, the switching unit 205, and the switching unit 206 are pivoted in such a manner that their leading ends are oriented upward. The sheet S is conveyed and discharged from a discharge roller pair 207 to the stacking unit 750 by the guiding of the switching unit 203, the switching unit 204, the switching unit 205, and the switching unit 206. That is, the discharge roller pair 207 is an example of a discharge unit, and conveys and discharges the sheet S to a stacking tray 251. A discharge sensor 216 that detects the sheet S is provided at the upstream in the sheet conveyance direction of the discharge roller pair 207.

In a case where the user designates, as a sheet discharge destination, a postprocessing device (not illustrated) connected at the downstream of the stacking module 700, the control unit 701 performs drive control of the switching unit 203 and the switching unit 204. The sheet S is conveyed (discharged) to the postprocessing device (not illustrated) by the guiding of the switching unit 203 and the switching unit 204, or the switching unit 205 and the switching unit 206 as desired.

A transfer mechanism 705 serving as an example of a transfer unit is arranged at the downstream in a draw-in direction X being a sheet discharge direction in which the sheet S is discharged from the discharge roller pair 207 to the stacking unit 750. The transfer mechanism 705 includes a driving pulley 211, a driven pulley 210, and a gripper belt 208 stretched around these pulleys. The gripper belt 208 is driven to rotate in a direction indicated by an arrow 212, by drive force of a gripper belt motor (not illustrated) being transmitted to the driving pulley 211 by a gear mechanism or the like. The gripper belt 208 is driven to rotate in such a manner that a traveling speed of its surface becomes the same speed as a sheet conveyance speed.

In addition, in the transfer mechanism 705, grippers 209a and 209b that grip the sheet S discharged from the discharge roller pair 207, with the gripper belt 208 by engaging with the leading end of the discharged sheet S are attached to the gripper belt 208. The grippers 209a and 209b serve as an example of a gripper member, and engage with the leading end of the sheet S discharged from the discharge roller pair 207. The grippers 209a and 209b move integrally with the gripper belt 208 in the direction indicated by the arrow 212, at the same speed as the sheet conveyance speed. Then, the sheet S is transferred (conveyed) up to a predetermined position in the sheet discharge direction above the stacking unit 750 by its leading end being gripped by the grippers 209a and 209b. That is, the transfer mechanism 705 includes the grippers 209a and 209b, and transfers the sheet S engaged with the grippers 209a and 209b, to the predetermined position above the stacking tray 251 and delivers the sheet S to a drawing unit 214 by pivoting the grippers 209a and 209b.

A leading end stopper 213 abuts against the leading end of the sheet S, and performs positioning of the sheet S. The leading end stopper 213 includes an incline surface 213a which the sheet S gripped by the grippers 209a and 209b comes into contact with, and the drawing unit 214 including a roller or the like that performs drawing of the sheet S. If the grippers 209a and 209b gripping the sheet S moves in the direction of the leading end stopper 213 by the rotation of the gripper belt 208, the leading end of the sheet S gripped by the grippers 209a and 209b comes into contact with the incline surface 213a of the leading end stopper 213. By the leading end of the sheet S coming into contact with the incline surface 213a, the gripping of the grippers 209a and 209b is cancelled (released).

After the sheet S is released from the grippers 209a and 209b, the sheet S is discharged toward the drawing unit 214, and the leading end of the sheet S comes into contact with a contact surface 213b of the leading end stopper 213 by the drawing unit 214, and the position of the sheet leading end is determined. In the present embodiment, the drawing unit 214 is assumed to be rotationally-moving roller, but the drawing unit 214 is not limited to this, and may be a rotationally-moving belt or the like. That is, the drawing unit 214 is arranged above the stacking tray 251, and moves in such a manner as to draw an uppermost sheet of the sheets S stacked on the stacking tray 251, in the draw-in direction X by having contact with the uppermost sheet. The contact surface 213b is an example of a stopper, is arranged at the downstream of the drawing unit 214 in the draw-in direction X, and determines the position by coming into contact with the leading end of the sheet S drawn in by the drawing unit 214. The sheet S is thereby transferred to the predetermined position above the stacking unit 750 (position where leading ends of the sheets S are aligned on the contact surface 213b). The predetermined position can be arbitrarily set by setting the position of the leading end stopper 213 to an arbitrary position above the stacking unit 750. In addition, in the present embodiment, the description has been given assuming that the leading end stopper 213 is fixed, but in a case where the sheets S are stacked on the stacking unit 750 while offsetting the sheets S, the leading end stopper 213 may be moved by a moving mechanism or the like each time offsetting is performed.

On the other hand, the trailing end of the sheet S escapes from the discharge roller pair 207 and gets away from the discharge roller pair 207, and the sheet S is stacked on the stacking tray 251 with the leading end position being regulated. The stacking tray 251 is an example of a stacking portion, and the sheet S is stacked thereon. Here, to stack the sheet S, the stacking tray 251 may be lowered. For this reason, if a sheet surface detection sensor 215 in the leading end stopper 213 detects a stacked sheet 240, tray lowering control of lowering the stacking tray 251 by a predetermined amount by the driving of a tray elevating motor 323 (refer to FIG. 3) is repeatedly performed.

In the case of taking out the stacked sheet S after the end of a job, or during a job, the stacking tray 251 is lowered up to a lower sheet extractable position. A trolley 260 on which the stacking tray 251 is placed is provided at the position to which the stacking tray 251 is lowered, and the stacking tray 251 on which the stacked sheets are placed is taken out from the stacking module 700 together with the trolley 260.

### Control System

Next, a control configuration of the stacking module 700 will be described with reference to FIG. 3. The control unit 701 includes a central processing unit (CPU), a memory, and the like, and controls each unit of the stacking module 700. The control unit 701 communicates with a main CPU 303 that controls the entire inkjet recording system 1.

In accordance with an instruction of the main CPU 303, the control unit 701 comprehensively controls the stacking module 700, mainly performs driving of each load in the stacking module 700, and sensor signal processing, and plays a role of executing module sequence control.

The control unit 701 communicates with a field programmable gate array (FPGA) 301. The control unit 701 supplies a control signal used for a solenoid drive circuit 310, a stepping motor drive circuit 311, and a brushless motor drive circuit 313, from the FPGA 301, and drives the solenoids 203a to 206a, a conveyance motor 321, and the tray elevating motor 323. The tray elevating motor 323 is an example of a motor, and outputs drive force for elevating and lowering the stacking tray 251.

By inputting signals of a conveyance sensor, the sheet surface detection sensor 215, and an encoder 324, the control unit 701 can perform sequence control of each load in accordance with an input signal of each sensor. Here, the encoder 324 is an example of a rotation detection unit that detects a rotation amount of the tray elevating motor 323, and is a sensor that performs rotation detection of the tray elevating motor 323. In addition, the tray elevating motor 323 is a brushless motor of a pulse width modulation (PWM) control method. By giving a PWM signal from the FPGA 301 to the brushless motor drive circuit 313, the brushless motor drive circuit 313 changes a voltage to be applied to the tray elevating motor 323, in accordance with a duty of the PWM signal.

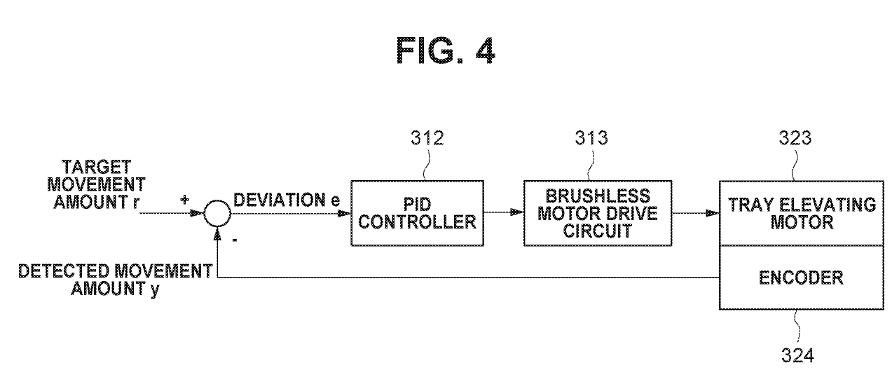

Next, a control method of the tray elevating motor 323 to be controlled by the control unit 701 will be described with reference to FIG. 4. As illustrated in FIG. 4, the control unit 701 performs position feedback control of the tray elevating motor 323 using (proportional integral derivative (PID) control as a control method. That is, the control unit 701 calculates a deviation between a target rotation amount and a detection result of the encoder 324, and executes feedback control by PID control of performing proportional control, integral control, and derivative control. In a case where the control unit 701 moves the tray elevating motor 323 by a predetermined amount, a target movement amount r is increased at every control cycle until the movement amount becomes the predetermined amount. The control unit 701 detects a rotation movement amount y of the tray elevating motor 323 at every control cycle using the encoder 324 attached to the tray elevating motor 323, and inputs a deviation e between the target movement amount r and the detected rotation movement amount y, to a PID controller 312.

The PID controller 312 directly multiplies the deviation e by a proportional gain Kp in a proportional term (P), multiplies an integrated value obtained by integrating the deviation e, by an integral gain Ki in an integral term (I), and multiplies a difference value indicating a difference between the deviation e and the previous deviation, by a derivative gain Kd in a derivative term (D). Then, the PID controller 312 adds up calculated values of the terms, and uses the added total value as a duty value of a PWM signal to be given to the brushless motor drive circuit 313. The brushless motor drive circuit 313 accordingly operates the tray elevating motor 323 by applying a voltage corresponding to the duty value, to the tray elevating motor 323. If the tray elevating motor 323 operates, the rotation movement amount y to be detected by the encoder 324 changes. Thus, a voltage to be applied to the tray elevating motor 323 changes in accordance with a rotation state. That is, when the control unit 701 lowers the stacking tray 251 in accordance with the sheet S being stacked on the stacking tray 251, the control unit 701 sets a target rotation amount of the tray elevating motor 323. Then, the control unit 701 performs feedback control of the tray elevating motor 323 based on the target rotation amount and a detection result of the encoder 324.

### Tray Lowering Control

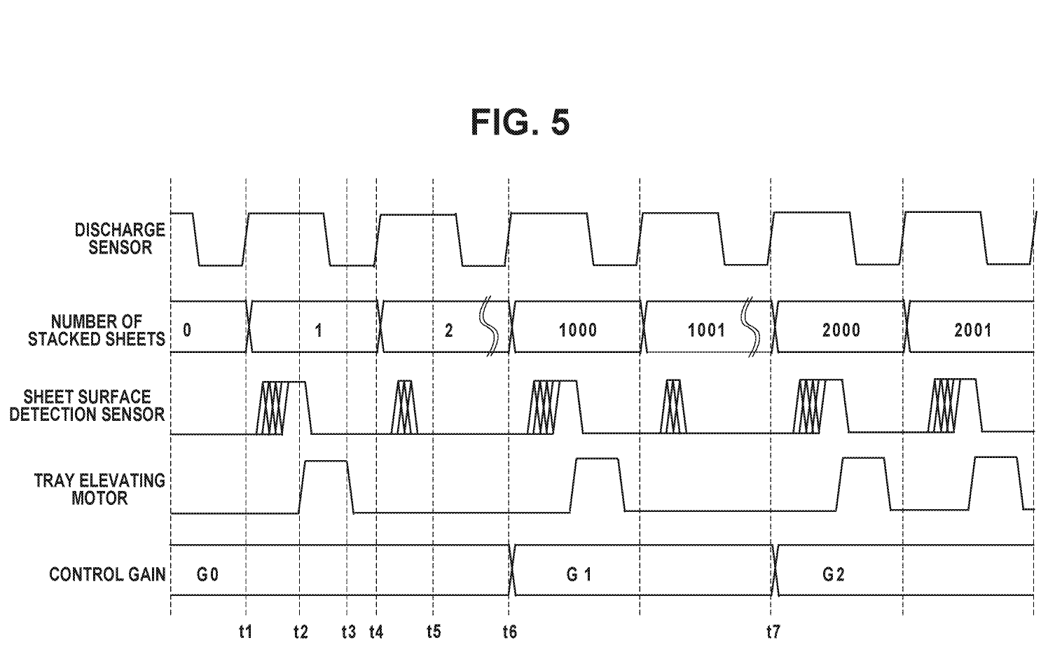

Next, tray lowering control of lowering the stacking tray 251 by a predetermined amount will be described with reference to FIG. 5. FIG. 5 is a timing chart of tray lowering control of lowering the stacking tray 251 by a predetermined amount in accordance with the stacking of the sheet S. As illustrated in FIG. 5, the control unit 701 starts the tray lowering control being triggered by the detection of a sheet trailing end passage by the discharge sensor 216. Here, the discharge sensor 216 indicates a sheet detected state as a low level, and a timing at which the discharge sensor 216 switches from the low level to a high level (e.g., time t1) corresponds to a sheet trailing end passage detection timing of the discharge sensor 216.

Because the discharge sensor 216 is a conveyance sensor arranged at the upstream of the stacking tray 251 in the sheet conveyance direction, a timing of the sheet trailing end passage detection of the discharge sensor 216 corresponds to a timing at which the sheet S is stacked on the stacking tray 251, and the sheet trailing end passage detection is synonymous with an increase in the number of stacked sheets.

At a time t2 after the lapse of a predetermined time from the time t1, the control unit 701 determines whether the sheet surface detection sensor 215 has detected a sheet surface. In a case where the control unit 701 determines that a sheet surface has been detected, the control unit 701 starts the driving of the tray elevating motor 323 by the above-described feedback control and stops the driving at a time t3 after the lapse of a predetermined time, resulting in lowering the stacking tray 251 by a predetermined amount.

Here, a state in which the sheet surface detection sensor 215 detects a sheet surface, and a state in which the tray elevating motor 323 is driven are indicated as the high level.

In the example illustrated in FIG. 5, at a time point between the times t1 to t2, the sheet S comes into contact with the leading end stopper 213 in which the sheet surface detection sensor 215 is arranged. Because the sheet surface detection sensor 215 sometimes detects the fluttering of the sheet S at the time of contact, the control unit 701 performs sheet surface detection at the time t2 corresponding to a timing at which the stacking of the sheet S is completed and the behavior of the sheet S stabilizes. As indicated at a time t5, in a case where the control unit 701 determines that the sheet surface detection sensor 215 has not detected a sheet surface at a timing at which the behavior of the sheet S stabilizes, the tray elevating motor 323 is not driven.

If the control unit 701 stops the driving of the tray elevating motor 323 at the time t3, the stacking tray 251 continues to lower by the inertia of the stacking tray 251, but because the tray elevating motor 323 is stopped, the stacking tray 251 vibrates. If the next sheet S is stacked in a state in which the stacking tray 251 vibrates, appropriate sheet surface detection cannot be performed. Thus, at the time t3 before a time t4 corresponding to a timing at which the next sheet S is stacked on the stacking tray 251, the driving of the tray elevating motor 323 may be stopped.

Because the above-described restriction is imposed on the time t2 at which the driving of the tray elevating motor 323 is started, and the time t3 at which the driving is stopped, a drive time of the tray elevating motor 323 of the stacking tray 251 becomes a short time. Because the drive time is short, driving is stopped before a lowering amount of the stacking tray 251 stably follows a target lowering amount. For this reason, a control gain is preliminarily adjusted in such a manner that a movement amount becomes a predetermined value at a stop timing of the tray elevating motor 323.

On the other hand, if the weight of the stacked sheets 240 increases in accordance with an increase in the number of stacked sheets, the inertia on a motor shaft of the tray elevating motor 323 increases. Thus, a movement amount transition at the time of motor drive start changes.

Specifically, a movement start of the tray gets delayed, an overshoot amount of exceeding the target movement amount, or an undershoot amount of falling below the target movement amount increases, and vibration increases as well. For this reason, in accordance with an increase in the weight of the stacked sheets 240, a movement amount obtainable when the tray elevating motor 323 is stopped changes, and a lowering amount of the stacking tray 251 might fluctuate.

If a lowering amount is smaller than a target movement amount, an interval between the drawing unit 214 and the stacking tray 251 becomes smaller as compared with the thickness of the conveyed sheet S, and the contact pressure between the drawing unit 214 and the conveyed sheet S becomes larger. Thus, crinkling and buckling of the sheet S might occur. If a lowering amount is larger than the target movement amount, an interval between the drawing unit 214 and the stacking tray 251 becomes larger as compared with the thickness of the conveyed sheet S, and the contact pressure between the drawing unit 214 and the conveyed sheet S becomes smaller. Thus, there is concern that the sheets S fail to be drawn in and aligned.

To avoid these risks, it is effective to change the above-described control gain of the feedback control of the tray elevating motor 323 in accordance with an increase in the weight of the stacked sheets 240 (i.e., increase in the number of stacked sheets). The control gain is a parameter for determining the responsiveness of the PID controller 312. For this reason, by changing the control gain in accordance with a responsiveness change of a control target that is attributed to the increase in the weight of the stacked sheets 240, it becomes possible to adjust transient vibration of the rotation movement amount y of the tray elevating motor 323.

As a result, it is possible to suppress a fluctuation in a lowering amount of the stacking tray 251. In FIG. 5, a control gain is set to G0 when the number of stacked sheets is zero, the control gain is changed to G1 at a time t6 at which the number of stacked sheets reaches 1000, and the control gain is changed to G2 at a time t7 at which the number of stacked sheets reaches 2000. Here, the weight of the stacked sheets 240 is a value obtained by multiplying the number of stacked sheets by a sheet weight of one sheet, and the sheet weight of one sheet is determined based on a sheet size and a sheet grammage. Thus, the number of stacked sheets for changing the control gain is changed in accordance with a sheet size and a sheet grammage. That is, the control unit 701 changes a control gain being an example of a control parameter of feedback control, in accordance with the weight of the sheets S stacked on the stacking tray 251 changing from a first weight (e.g., weight corresponding to one sheet) to a second weight (e.g., weight corresponding to 1000 sheets) heavier than the first weight.

Here, if the weight of a control target increases, the respondence of the system gets slower, and vibration or overshoot might occur. In view of the foregoing, in a case where the weight of sheets becomes larger, a feedback control parameter of tray elevating/lowering control is changed in such a manner as to increase a response speed to tray lowering, and suppress overshoot and vibration. That is, it is considered that the proportional gain Kp is increased to increase the response speed, the integral gain Ki is decreased to suppress overshoot, and the derivative gain Kd is increased to suppress vibration. Nevertheless, if the proportional gain Kp is increased too much, vibration occurs, if the integral gain Ki is decreased too much, a positional shift attributed to a steady-state deviation occurs, and if the derivative gain Kd is increased too much, the system becomes sensitive to external noise. Thus, appropriate adjustment may be made.

In view of the foregoing, in the present embodiment, as an example, the proportional gain Kp is increased, the integral gain Ki is decreased, and the derivative gain Kd is increased in accordance with the number of stacked sheets as an example of a change of a control gain G.

That is, the control unit 701 performs feedback control in such a manner as to increase a response speed by increasing the proportional gain Kp as a control parameter, in accordance with the weight of the sheets S stacked on the stacking tray 251, becoming larger. In addition, the control unit 701 performs feedback control in such a manner as to decrease overshoot by decreasing the integral gain Ki as a control parameter, in accordance with the weight of the sheets S stacked on the stacking tray 251, becoming larger. In addition, the control unit 701 performs feedback control in such a manner as to decrease vibration by increasing the derivative gain Kd as a control parameter, in accordance with the weight of the sheets S stacked on the stacking tray 251, becoming larger.

Specifically, when the number of stacked sheets is zero, the proportional gain Kp, the integral gain Ki, and the derivative gain Kd are set to 1. In this case, when the number of stacked sheets is 1000 or more, the proportional gain Kp is set to 2, the integral gain Ki is set to 0.5, and the derivative gain Kd is set to 2. When the number of stacked sheets is 2000 or more, the proportional gain Kp is set to 4, the integral gain Ki is set to 0.25, and the derivative gain Kd is set to 4. In this manner, by appropriately adjusting the control gain G in accordance with an increase in the number of stacked sheets, the stability and responsiveness of the system can be maintained. In the present embodiment, all of the proportional gain Kp, the integral gain Ki, and the derivative gain Kd are changed, but the configuration is not limited to this, and it is sufficient that at least one of these is changed.

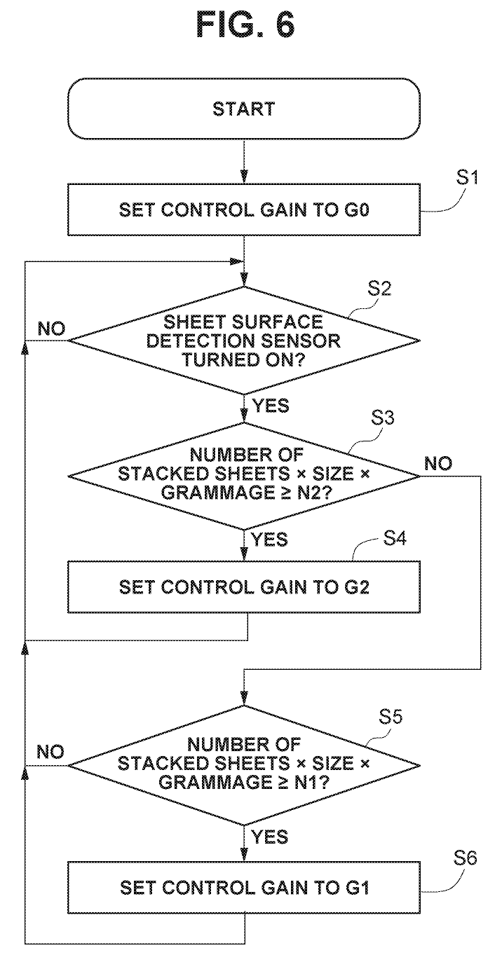

Next, an operation procedure of the control unit 701 will be described with reference to a flowchart illustrated in FIG. 6. Processing in each control step is performed by the control unit 701. When the control unit 701 is powered on and activated, this flow starts. In step S1, the control unit 701 sets a control gain of the tray elevating motor 323 to a default value G0. In step S2, the control unit 701 determines whether the sheet surface detection sensor 215 is in an ON state. In a case where the control unit 701 determines that the sheet surface detection sensor 215 is not in the ON state (NO in step S2), the processing returns to step S2. In step S2, the control unit 701 determines again whether the sheet surface detection sensor 215 is in the ON state.

In a case where the control unit 701 determines that the sheet surface detection sensor 215 is in the ON state (YES in step S2), the processing proceeds to step S3. In step S3, the control unit 701 determines whether the acquired number of stacked sheets × sheet size × sheet grammage is equal to or larger than a predetermined value N2. In a case where the control unit 701 determines that the number of stacked sheets × sheet size × sheet grammage is equal to or larger than the predetermined value N2 (YES in step S3), the processing proceeds to step S4. In step S4, the control unit 701 sets the control gain to G2, and the processing returns to step S2. In step S2, the control unit 701 determines again whether the sheet surface detection sensor 215 is in the ON state.

In a case where the control unit 701 determines that the number of stacked sheets × sheet size × sheet grammage is not equal to or larger than the predetermined value N2 (NO in step S3), the processing proceeds to step S5. In step S5, the control unit 701 determines whether the acquired number of stacked sheets × sheet size × sheet grammage is equal to or larger than a predetermined value N1. In a case where the control unit 701 determines that the number of stacked sheets × sheet size × sheet grammage is equal to or larger than the predetermined value N1 (YES in step S5), the processing proceeds to step S6. In step S6, the control unit 701 sets the control gain to G1, and the processing returns to step S2. In step S2, the control unit 701 determines again whether the sheet surface detection sensor 215 is in the ON state. In a case where the control unit 701 determines that the number of stacked sheets × sheet size × sheet grammage is not equal to or larger than the predetermined value N1 (NO in step S5), the processing returns to step S2. In step S2, the control unit 701 determines again whether the sheet surface detection sensor 215 is in the ON state.

In the present embodiment, here, three stages of G0, G1, and G2 are used as the stages of gain setting, but the stages are not limited to these, and the number of stages may be changed in accordance with a product configuration. In addition, even in the same product, the number of stages may be changed in accordance with a sheet type, a temperature and humidity environment, and a stacking condition such as a stacking speed.

As described above, according to the present embodiment, the control unit 701 monitors the sheet surface detection sensor 215, and changes a control gain of the tray elevating motor 323 in accordance with the number of stacked sheets × sheet size × sheet grammage (i.e., stacked sheet weight). That is, in the present embodiment, the control unit 701 changes a control gain of feedback control in accordance with the weight of the sheets S stacked on the stacking tray 251, getting heavier. Accordingly, it becomes possible to optimize the stability and responsiveness of a motor control system, and it is possible to improve the positional accuracy of the stacking tray 251 by improving the alignment of stacked sheets and suppressing a stacking failure.

In the above-described embodiment, the description has been given of a case where the control unit 701 executes feedback control by PID control, but the configuration is not limited to this. For example, instead of using all of three types of control including proportional control, integral control, and derivative control, two types of control from these may be executed in combination, or only one type of control may be executed.

In addition, in the above-described embodiment, the description has been given of a case where the control unit 701 acquires the weight of stacked sheets S by calculating the number of stacked sheets × sheet size × sheet grammage, but the configuration is not limited to this. For example, a sensor that can directly detect the weight of sheets S stacked on the stacking tray 251 may be provided.

In addition, in the above-described embodiment, the change of a motor control gain is implemented in a software manner in the control unit 701. Nevertheless, the configuration is not limited to this, and an equivalent function may be implemented in a hardware manner using a transistor and a discrete IC.

In addition, in the above-described embodiment, the description has been given of a case where a sheet stacking apparatus is applied to the stacking module 700 as an example, but the configuration is not limited to this. For example, the sheet stacking apparatus can be made adaptable to a location where a large number of sheets are to be stacked. Specifically, for example, the sheet stacking apparatus can be applied even to an apparatus that stacks sheets and does not use a gripper belt, such as a large capacity stacker, a discharge tray of a finisher, and a large capacity feeding deck.

In addition, in the above-described embodiment, the description has been given of a case where an image forming system is applied to the inkjet recording system 1 employing an inkjet recording method, but the configuration is not limited to this. The image forming system may be applied to an image forming apparatus employing an electrophotographic method.

### Second Embodiment

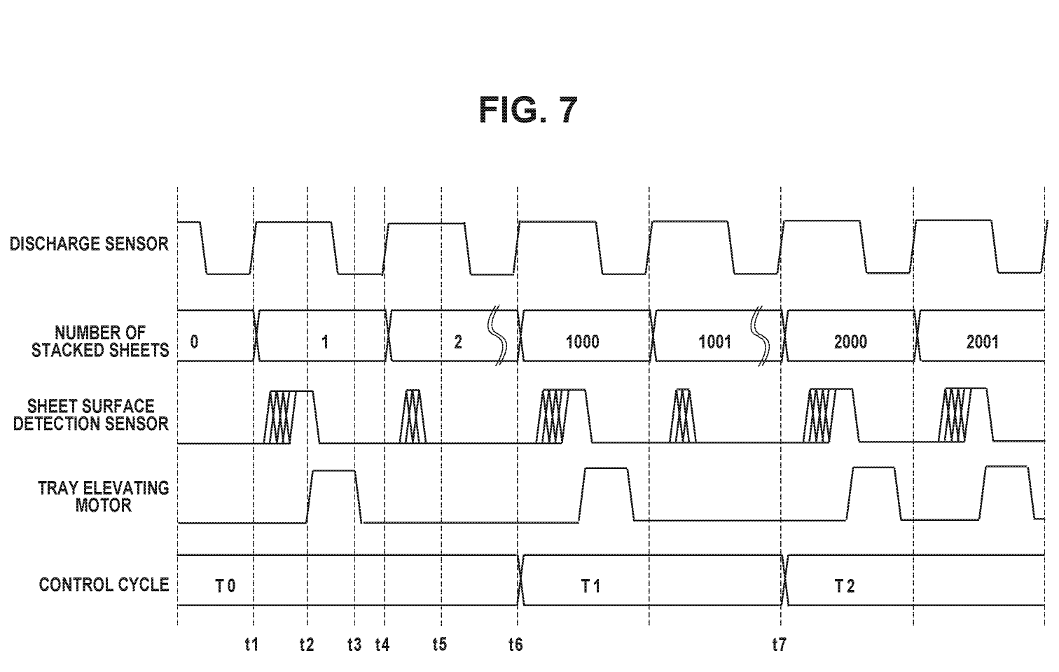

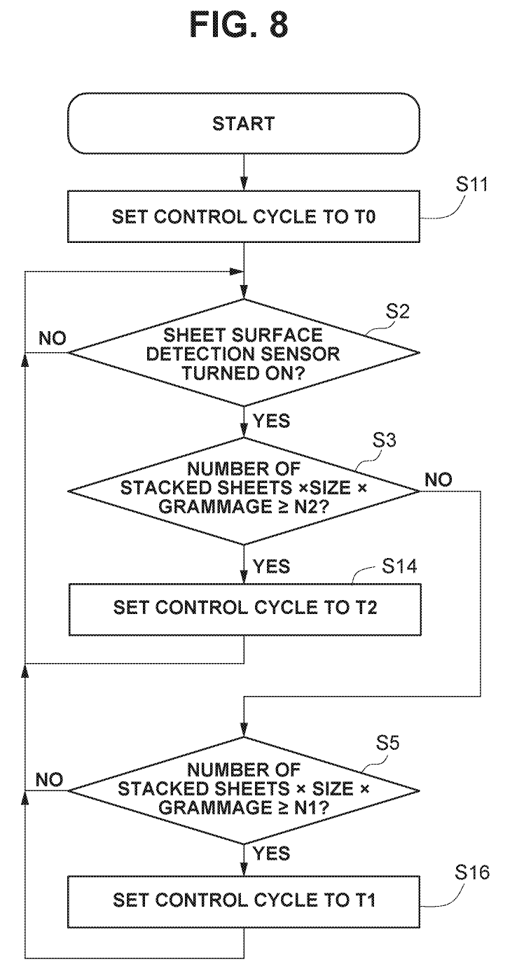

Next, the second embodiment will be described with reference to FIGS. 7 and 8. The configuration of the present embodiment differs from the first embodiment in that a control cycle is used as a control parameter instead of a control gain. Because the other configurations are similar to those in the first embodiment, the same reference numerals are allocated, and the detailed description will be omitted.

In the present embodiment, because a control block is the same as that in the first embodiment, the description will be given using the control block diagram in FIG. 4. In the first embodiment, a control gain of the PID controller 312 is changed based on a stacked sheet weight, but in the second embodiment, a control cycle at which PID control is calculated is changed instead of changing the control gain of the PID controller 312 based on a stacked sheet weight. By changing the control cycle, it is possible to obtain an effect equivalent to the effect caused by the change of a control gain, by changing an integrated value of the deviation e, and a difference value between the deviation e and the previous deviation.

### Tray Lowering Control

Tray lowering control of lowering the stacking tray 251 by a predetermined amount will be described with reference to FIG. 7. FIG. 7 is a timing chart of tray lowering control of lowering the stacking tray 251 by a predetermined amount in accordance with the stacking of the sheet S according to the present embodiment. A difference from FIG. 5 lies in that a parameter to be changed in accordance with an increase in the number of stacked sheets is changed from a control gain to a control cycle. The other configurations are similar to those in the first embodiment.

In view of the foregoing, in the first embodiment, as an example, in accordance with the number of stacked sheets, the proportional gain Kp is increased, the integral gain Ki is decreased, and the derivative gain Kd is increased, as an example of the change of the control gain G. That is, the control unit 701 performs feedback control in such a manner as to increase a response speed by increasing the proportional gain Kp as a control parameter, in accordance with the weight of the sheets S stacked on the stacking tray 251, becoming larger. In addition, the control unit 701 performs feedback control in such a manner as to decrease overshoot by decreasing the integral gain Ki as a control parameter, in accordance with the weight of the sheets S stacked on the stacking tray 251, becoming larger. In addition, the control unit 701 performs feedback control in such a manner as to reduce vibration by increasing the derivative gain Kd as a control parameter, in accordance with the weight of the sheets S stacked on the stacking tray 251, becoming larger.

Here, regarding proportional control, by shortening a control cycle, responsiveness improves because an update speed of the deviation e to be detected increases. Thus, by shortening a proportional control cycle, an effect equivalent to the effect to be obtained by increasing the proportional gain Kp is obtained. For this reason, the control unit 701 performs feedback control in such a manner as to increase a response speed by shortening a control cycle of proportional control as a control parameter, in accordance with the weight of the sheets S stacked on the stacking tray 251, becoming larger.

Regarding integral control, by elongating a control cycle, overshoot is suppressed because an integration speed of the deviation e to be detected decreases. Thus, by elongating an integral control cycle, an effect equivalent to the effect to be obtained by decreasing the integral gain Ki is obtained. For this reason, the control unit 701 performs feedback control in such a manner as to decrease overshoot by elongating a control cycle of integral control as a control parameter, in accordance with the weight of the sheets S stacked on the stacking tray 251, becoming larger.

Regarding derivative control, by shortening a control cycle, sensitivity to noise increases because an update speed of the deviation e to be detected increases. Thus, by shortening a derivative control cycle, an effect equivalent to the effect to be obtained by increasing the derivative gain Kd is obtained. For this reason, the control unit 701 performs feedback control in such a manner as to reduce vibration by shortening a control cycle of derivative control as a control parameter, in accordance with the weight of the sheets S stacked on the stacking tray 251, becoming larger.

Accordingly, as an example of a change of a control cycle, in accordance with the number of stacked sheets, a proportional control cycle is decreased, an integral control cycle is increased, and a derivative control cycle is increased. For example, as illustrated in FIG. 7, when the number of stacked sheets is zero, a control cycle is set to T0, the control cycle is changed to T1 at a time t6 at which the number of stacked sheets reaches 1000, and the control cycle is changed to T2 at a time t7 at which the number of stacked sheets reaches 2000.

Specifically, in a case where a proportional control cycle, an integral control cycle, and a derivative control cycle are set to 2 ms (millisecond) when the number of stacked sheets is zero, when the number of stacked sheets is 1000 or more, a proportional control cycle is set to 1 ms, an integral control cycle is set to 4 ms, and a derivative control cycle is set to 1 ms. In addition, when the number of stacked sheets is 2000 or more, a proportional control cycle is set to 0.5 ms, an integral control cycle is set to 8 ms, and a derivative control cycle is set to 0.5 ms. In this manner, by appropriately adjusting a control cycle in accordance with an increase in the number of stacked sheets, the stability and responsiveness of the system can be maintained. In the present embodiment, all of the proportional control cycle, the integral control cycle, and the derivative control cycle are changed, but the configuration is not limited to this, and it is sufficient that at least one of these is changed.

Next, an operation procedure of the control unit 701 will be described with reference to a flowchart illustrated in FIG. 8. Processing in each control step is performed by the control unit 701. When the control unit 701 is powered on and activated, this flow starts. In step S11, the control unit 701 sets a control cycle of the tray elevating motor 323 to a default value T0. In step S2, the control unit 701 determines whether the sheet surface detection sensor 215 is in the ON state. In a case where the control unit 701 determines that the sheet surface detection sensor 215 is not in the ON state (NO in step S2), the processing returns to step S2. In step S2, the control unit 701 determines again whether the sheet surface detection sensor 215 is in the ON state.

In a case where the control unit 701 determines that the sheet surface detection sensor 215 is in the ON state (YES in step S2), the processing proceeds to step S3. In step S3, the control unit 701 determines whether the number of stacked sheets × sheet size × sheet grammage is equal to or larger than a predetermined value N2. In a case where the control unit 701 determines that the number of stacked sheets × sheet size × sheet grammage is equal to or larger than the predetermined value N2 (YES in step S3), the processing proceeds to step S14. In step S14, the control unit 701 sets the control cycle to T2, and the processing returns to step S2. In step S2, the control unit 701 determines again whether the sheet surface detection sensor 215 is in the ON state.

In a case where the control unit 701 determines that the number of stacked sheets × sheet size × sheet grammage is not equal to or larger than the predetermined value N2 (NO in step S3), the processing proceeds to step S5. In step S5, the control unit 701 determines whether the number of stacked sheets × sheet size × sheet grammage is equal to or larger than a predetermined value N1. In a case where the control unit 701 determines that the number of stacked sheets × sheet size × sheet grammage is equal to or larger than the predetermined value N1 (YES in step S5), the processing proceeds to

step S16. In step S16, the control unit 701 sets the control cycle to T1, and the processing returns to step S2. In step S2, the control unit 701 determines again whether the sheet surface detection sensor 215 is in the ON state. In a case where the control unit 701 determines that the number of stacked sheets × sheet size × sheet grammage is not equal to or larger than the predetermined value N1 (NO in step S5), the processing returns to step S2. In step S2, the control unit 701 determines again whether the sheet surface detection sensor 215 is in the ON state.

In the present embodiment, here, three stages of T0, T1, and T2 are used as the stages of cycle setting, but the stages are not limited to these, and the number of stages may be changed in accordance with a product configuration. In addition, even in the same product, the number of stages may be changed in accordance with a sheet type, a temperature and humidity environment, and a stacking condition such as a stacking speed.

As described above, according to the present embodiment, the control unit 701 monitors the sheet surface detection sensor 215, and changes a control cycle of the tray elevating motor 323 in accordance with the number of stacked sheets × sheet size × sheet grammage (i.e., stacked sheet weight). That is, in the present embodiment, the control unit 701 changes a control cycle of feedback control in accordance with the weight of the sheets S stacked on the stacking tray 251, getting heavier. Accordingly, it becomes possible to optimize the stability and responsiveness of a motor control system, and it is possible to improve the positional accuracy of the stacking tray 251 by improving the alignment of stacked sheets and suppressing a stacking failure.

In the above-described embodiment, the control unit 701 changes a control parameter in accordance with the weight of stacked sheets S, but the configuration is not limited to this. For example, a control parameter may be changed in accordance with the height of the stacking tray 251. That is, if the weight of the sheets S stacked on the stacking tray 251 gets heavier, the height of the stacking tray 251 gets lower. Thus, such correlation between a sheet weight and the height of the stacking tray 251 is utilized.

For example, a height detection sensor 261 (refer to FIG. 2) is provided as an example of a height detection unit that detects the height of the stacking tray 251. Then, when the stacking tray 251 is lowered, the control unit 701 may set a target height of the stacking tray 251, and perform feedback control of the tray elevating motor 323 based on the target height and a detection result of the height detection sensor 261.

In this case, the control unit 701 changes a control parameter of feedback control in accordance with the height of the stacking tray 251 changing from a first height to a second height lower than the first height. The control parameter may be a control gain as in the first embodiment, or may be a control cycle as in the second embodiment.

According to the present disclosure, it is possible to improve the positional accuracy of a stacking tray.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-230578, filed December 26, 2024, which is hereby incorporated by reference herein in its entirety.

What is claimed is:

1. A sheet stacking apparatus comprising:
a stacking portion on which a sheet is to be stacked;
a motor configured to output drive force for elevating and lowering the stacking portion;
a rotation detection unit configured to detect a rotation amount of the motor; and
a control unit configured to set a target rotation amount of the motor when the stacking portion is lowered in accordance with a sheet being stacked on the stacking portion, and perform feedback control of the motor based on the target rotation amount and a detection result of the rotation detection unit,
wherein the control unit changes a control parameter of the feedback control in accordance with information related to a weight of sheets stacked on the stacking portion.

2. The sheet stacking apparatus according to claim 1,
wherein, in a case where a weight of sheets stacked on the stacking portion is a first weight, the control unit sets a proportional gain to a first value as the control parameter, and
wherein, in a case where a weight of sheets stacked on the stacking portion is a second weight larger than the first weight, the control unit sets the proportional gain to a second value larger than the first value, as the control parameter.

3. The sheet stacking apparatus according to claim 1,
wherein, in a case where a weight of sheets stacked on the stacking portion is a first weight, the control unit sets an integral gain to a first value as the control parameter, and
wherein, in a case where a weight of sheets stacked on the stacking portion is a second weight larger than the first weight, the control unit sets the integral gain to a second value smaller than the first value, as the control parameter.

4. The sheet stacking apparatus according to claim 1,
wherein, in a case where a weight of sheets stacked on the stacking portion is a first weight, the control unit sets a derivative gain to a first value as the control parameter, and
wherein, in a case where a weight of sheets stacked on the stacking portion is a second weight larger than the first weight, the control unit sets the derivative gain to a second value larger than the first value, as the control parameter.

5. The sheet stacking apparatus according to claim 1,
wherein, in a case where a weight of sheets stacked on the stacking portion is a first weight, the control unit sets a control cycle of proportional control to a first cycle as the control parameter, and
wherein, in a case where a weight of sheets stacked on the stacking portion is a second weight larger than the first weight, the control unit sets the control cycle of the proportional control to a second cycle shorter than the first cycle, as the control parameter.

6. The sheet stacking apparatus according to claim 1,
wherein, in a case where a weight of sheets stacked on the stacking portion is a first weight, the control unit sets a control cycle of integral control to a first cycle as the control parameter, and
wherein, in a case where a weight of sheets stacked on the stacking portion is a second weight larger than the first weight, the control unit sets the control cycle of the integral control to a second cycle longer than the first cycle, as the control parameter.

7. The sheet stacking apparatus according to claim 1,
wherein, in a case where a weight of sheets stacked on the stacking portion is a first weight, the control unit sets a control cycle of derivative control to a first cycle as the control parameter, and
wherein, in a case where a weight of sheets stacked on the stacking portion is a second weight shorter than the first weight, the control unit sets the control cycle of the derivative control to a second cycle longer than the first cycle, as the control parameter.

8. The sheet stacking apparatus according to claim 1, wherein the control unit executes feedback control by PID control of performing proportional control, integral control, and derivative control by calculating a deviation between the target rotation amount and a detection result of the rotation detection unit.

9. The sheet stacking apparatus according to claim 1, wherein the motor is a brushless motor.

10. The sheet stacking apparatus according to claim 1, wherein the control unit acquires a weight of sheets stacked on the stacking portion, based on a size and a grammage of a sheet, and the number of sheets.

11. The sheet stacking apparatus according to claim 1, further comprising:
a drawing unit that is arranged above the stacking portion, and is configured to move in such a manner as to draw an uppermost sheet of sheets stacked on the stacking portion, in a draw-in direction by having contact with the uppermost sheet; and
a stopper that is arranged at a downstream of the drawing unit in the draw-in direction, and is configured to determine a position of a sheet drawn in by the drawing unit, by having contact with a leading end of the sheet.

12. The sheet stacking apparatus according to claim 11, further comprising:
a discharge unit configured to convey and discharge a sheet to the stacking portion; and
a transfer unit that includes a gripper member that engages with a leading end of a sheet discharged from the discharge unit, and is configured to transfer the sheet engaged with the gripper member by pivoting the gripper member, to a predetermined position above the stacking portion, and deliver the sheet to the drawing unit.

13. A sheet stacking apparatus comprising:
a stacking portion on which a sheet is to be stacked;
a motor configured to output drive force for elevating and lowering the stacking portion;
a rotation detection unit configured to detect a rotation amount of the motor; and
a control unit configured to set a target rotation amount of the motor when the stacking portion is lowered in accordance with a sheet being stacked on the stacking portion, and perform feedback control of the motor based on the target rotation amount and a detection result of the rotation detection unit,
wherein the control unit changes a control parameter of the feedback control in accordance with the number of sheets stacked on the stacking portion.

14. The sheet stacking apparatus according to claim 13,
wherein, in a case where the number of sheets stacked on the stacking portion is a first number, the control unit sets a proportional gain to a first value as the control parameter, and
wherein, in a case where the number of sheets stacked on the stacking portion is a second number larger than the first number, the control unit sets the proportional gain to a second value larger than the first value, as the control parameter.

15. The sheet stacking apparatus according to claim 13,
wherein, in a case where the number of sheets stacked on the stacking portion is a first number, the control unit sets an integral gain to a first value as the control parameter, and
wherein, in a case where the number of sheets stacked on the stacking portion is a second number larger than the first number, the control unit sets the integral gain to a second value smaller than the first value, as the control parameter.

16. A sheet stacking apparatus comprising:
a stacking portion on which a sheet is to be stacked;
a motor configured to output drive force for elevating and lowering the stacking portion;
a rotation detection unit configured to detect a rotation amount of the motor; and
a control unit configured to set a target rotation amount of the motor when the stacking portion is lowered in accordance with a sheet being stacked on the stacking portion, and perform feedback control of the motor based on the target rotation amount and a detection result of the rotation detection unit,
wherein the control unit changes a control parameter of the feedback control in accordance with a size of a sheet stacked on the stacking portion.

17. A sheet stacking apparatus comprising:
a stacking portion on which a sheet is to be stacked;
a motor configured to output drive force for elevating and lowering the stacking portion;
a rotation detection unit configured to detect a rotation amount of the motor; and
a control unit configured to set a target rotation amount of the motor when the stacking portion is lowered in accordance with a sheet being stacked on the stacking portion, and perform feedback control of the motor based on the target rotation amount and a detection result of the rotation detection unit,
wherein the control unit changes a control parameter of the feedback control in accordance with a grammage of a sheet stacked on the stacking portion.

18. An image forming system comprising:
an image forming apparatus configured to form an image on a sheet; and
the sheet stacking apparatus according to claim 1 that is configured to receive a sheet on which an image is formed by the image forming apparatus, and stack the sheet on the stacking portion.
